(19) United States
(12) Patent Application Publication
(10) Pub. No.: US 2025/0053229 A1
(43) Pub. Date: Feb. 13, 2025

(54) WEARABLE DISPLAY DEVICE, DETECTION METHOD, AND RECORDING MEDIUM

(71) Applicant: Sony Group Corporation, Tokyo (JP)

(72) Inventors: Masahito OTA, Kanagawa (JP); Takaaki YOSHIDA, Kanagawa (JP)

(73) Assignee: Sony Group Corporation, Tokyo (JP)

(21) Appl. No.: 18/683,251

(22) PCT Filed: Mar. 18, 2022
(86) PCT No.: PCT/JP2022/012746

§ 371 Date: Feb. 13, 2024

(30) Foreign Application Priority Data
Aug. 26, 2021 (JP) 2021-138152

(51) Int. Cl. G06F 3/01

(52) U.S. Cl. CPC G06F 3/012

(57) ABSTRACT

A wearable display device includes a change detection unit that detects a change in a wearing state of a display unit, which is worn on a head of a user and emits light for forming a display image to an eyeball of the user, by comparing a detection result of movement of the display unit and a detection result of movement of the head.

### TECHNICAL FIELD

The present technology relates to a wearable display device, a detection method, and a recording medium, and particularly relates to technology of a wearable display device to be worn on a head of a user.

### BACKGROUND ART

With regard to a wearable display device, there has been proposed a device that detects positional deviation between an eyeball of a user and the wearable display device, that is, mounting deviation of the wearable display device, by emitting infrared rays to both eyes of the user in a horizontal direction and estimating right and left eyeball positions of the user by reflected light thereof using a scleral reflection method (e.g., see Patent Document 1).

### CITATION LIST

### Patent Document

Patent Document 1: International Publication Pamphlet No. WO 2014/017348

### SUMMARY OF THE INVENTION

### Problems to be Solved by the Invention

However, according to the wearable display device described above, it has been necessary to mount, near the eyeballs of the user, an infrared sensor including an irradiation unit that emits infrared rays and a light receiving portion that receives reflected light.

In addition, according to the wearable display device described above, mounting deviation may be erroneously detected when an amount of received reflected light changes due to an influence of external light or the like, whereby it has been necessary to cover the periphery of the eyeballs to reduce the influence of the external light.

As described above, there has been a problem that restrictions on a structure become larger according to the wearable display device described above.

In view of the above, the present technology aims to reduce restrictions on a structure.

### Solutions to Problems

A wearable display device according to the present technology includes a change detection unit that detects a change in a wearing state of a display unit, which is worn on a head of a user and emits light for forming a display image to an eyeball of the user, by comparing a detection result of movement of the display unit and a detection result of movement of the head.

With this arrangement, the wearable display device is enabled to detect the change in the wearing state of the display unit only by adopting a structure for measuring information required to detect the movement of the display unit and the movement of the head.

### BRIEF DESCRIPTION OF DRAWINGS

FIG. 1 is a diagram for explaining a configuration of a wearable display device according to an embodiment.

FIG. 2 is a diagram for explaining an optical structure of a display unit.

FIG. 3 is a diagram for explaining a relationship between the display unit and an eye box and an eyeball of a user.

FIG. 4 is a diagram for explaining a functional configuration of the wearable display device.

FIG. 5 is a flowchart illustrating a flow of a mounting deviation detection correction process.

FIG. 6 is a flowchart illustrating a flow of a calibration process.

FIG. 7 is a diagram for explaining a display image for eye box adjustment.

FIG. 8 is a diagram for explaining a calibration image.

FIG. 9 is a flowchart illustrating a flow of a mounting deviation detection process.

FIG. 10 is a flowchart illustrating a flow of an exceptional process.

FIG. 11 is a diagram for explaining a specific example of the mounting deviation detection process.

FIG. 12 is a diagram for explaining a mounting deviation correction process.

FIG. 13 is a diagram for explaining a display image displayed in the mounting deviation correction process.

### MODE FOR CARRYING OUT THE INVENTION

Hereinafter, an embodiment will be described in the following order.

<1. Wearable display device>

[1.1 Configuration of wearable display device]

[1.2 Optical structure of display unit 2]

[1.3 Eye box]

[1.4 Functional configuration of wearable display

device 1]

<2. Mounting deviation detection correction process>

[2.1 Calibration process]

[2.2 Mounting deviation detection process]

[2.3 Exceptional process]

[2.4 Mounting deviation correction process]

<3. Variations>

<4. Summary of embodiment>

<5. Present technology>

<1. Wearable display device>

### [1.1 Configuration of Wearable Display Device]

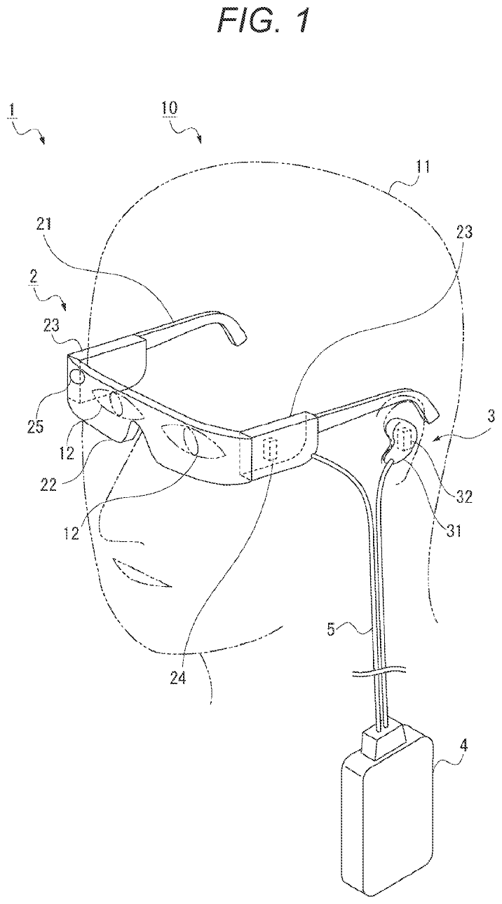

FIG. 1 is a diagram illustrating a configuration of a wearable display device 1 as an embodiment according to the present technology.

The wearable display device 1 is a device capable of implementing what is called augmented reality (AR) technology that superimposes a virtual object (virtual image) based on a display image on a real space (real image) to be visually recognized.

As illustrated in FIG. 1, the wearable display device 1 includes a display unit 2 to be worn on a head 11 of a user 10, speaker units 3 to be worn on ears of the user 10, and an information processing unit 4 to be connected to the display unit 2 and the speaker units 3 via cables 5.

The display unit 2 is a transmissive (optical see-through) head-mounted display that allows the user 10 to visually recognize the real space. The display unit 2 is worn on the head 11 of the user 10, and emits light for forming a display image to eyeballs 12 of the user 10, thereby causing a virtual object based on the display image to be superimposed on the real space and visually recognized.

The display unit 2 includes a frame 21, an emission unit 22, image forming units 23, a six degrees of freedom (6DoF) sensor 24, and an external recognition camera 25.

The frame 21 is formed in a spectacle type, for example, and the emission unit 22, the image forming units 23, the 6DoF sensor 24, and the external recognition camera 25 are fixed thereto. Both ends of the frame 21 are respectively locked to both ears of the user 10.

The emission unit 22 is fixed to the frame 21 to be disposed to face the eyeballs 12 of the user 10 when the display unit 2 is worn on the head 11 of the user 10.

Furthermore, a nose pad that may be locked to the nose of the user 10 is provided at the center of the emission unit 22. Thus, the display unit 2 is worn on the head 11 of the user 10 by being supported by the three points of both ears and the nose of the user 10. With this arrangement, the display unit 2 is normally moved together with the movement of the head 11 of the user 10 without changing the relative position with respect to the head 11 of the user 10.

The image forming units 23 are provided on the respective right and left sides with the emission unit 22 interposed therebetween, and generate light for forming a display image to be visually recognized as a virtual object by being emitted to each of the right and left eyeballs 12 of the user 10. The image forming units 23 may generate monochromatic light for forming a monochromatic display image, or may generate light of at least three colors or more for forming a full-color display image.

The emission unit 22 guides the light generated by the image forming units 23 to positions facing the eyeballs 12 of the user 10, and emits the light to each of the right and left eyeballs 12 of the user 10.

Specifically, the light generated by the image forming unit 23 provided on the left side of the emission unit 22 is guided to a position facing the left eyeball 12 of the user 10 by the emission unit 22, and is emitted to the left eyeball 12 of the user 10. In addition, the light generated by the image forming unit 23 on the right side of the emission unit 22 is guided to a position facing the right eyeball 12 of the user 10 by the emission unit 22, and is emitted to the right eyeball 12 of the user 10.

By visually recognizing the light (display image) emitted from the emission unit 22, the user 10 is enabled to visually recognize the virtual object as if it is superimposed on the real space.

The 6DoF sensor 24 corresponds to a first sensor, which is provided in the image forming unit 23 provided on the left side of the emission unit 22, for example, and measures a position and an attitude of the display unit 2.

Specifically, in the 6DoF sensor 24, an xyz coordinate system (first coordinate system) including three axes of an x-axis, y-axis, and a z-axis is set, and positions in the respective x-axis, y-axis, and z-axis directions and rotations around the respective x-axis, y-axis, and z-axis (roll, pitch, and yaw) are measured.

That is, the 6DoF sensor 24 measures the positions in the x-axis, y-axis, and z-axis directions as a position of the display unit 2, and measures the rotations around the x-axis, y-axis, and z-axis as an attitude of the display unit 2.

Note that, while the 6DoF sensor 24 may be provided anywhere as long as it can detect the position and the attitude of the display unit 2, it is preferably provided in the display unit 2.

The external recognition camera 25 is provided at the right end of the emission unit 22, for example, and captures an image of the front of the display unit 2. That is, the external recognition camera 25 captures an image of the real space that the user 10 is visually seeing.

The speaker unit 3 is, for example, a canal-type earphone, and includes a speaker 31 and a 6DoF sensor 32. Two speaker units 3 are provided, which are worn on both ears of the user 10. Thus, by being worn on the ears of the user 10, the speaker units 3 move together with the head 11 without changing the relative positions with respect to the head 11 of the user 10 along with the movement of the head 11 of the user 10.

Note that the speaker unit 3 to be worn on the right ear of the user 10 is omitted in FIG. 1. In addition, while the speaker unit 3 may be an inner-ear type earphone, an ear-hanging type earphone, or a headphone, it is preferably a canal-type earphone having higher followability to the movement of the user 10.

The speaker 31 outputs a sound to the ear of the user 10.

The 6DoF sensor 32 is provided in the speaker unit 3 to be worn on the left ear of the user 10, for example, and measures a position and an attitude of the speaker unit 3.

Specifically, in the 6DoF sensor 32 that corresponds to a second sensor, an x′y′z′ coordinate system (second coordinate system) including three axes of an x′-axis, y′-axis, and a z′-axis is set, and positions in the respective x′-axis, y′-axis, and z′-axis directions and rotations around the respective x′-axis, y′-axis, and z′-axis (roll, pitch, and yaw) are measured.

That is, the 6DoF sensor 32 measures the positions in the x′-axis, y′-axis, and z′-axis directions as a position of the speaker unit 3, and measures the rotations around the x′-axis, y′-axis, and z′-axis as an attitude of the speaker unit 3.

Here, as described above, the speaker unit 3 moves without changing the relative position with respect to the head 11 of the user 10. Thus, it can be said that the 6DoF sensor 32 measures a position and an attitude of the head 11 of the user 10 by measuring the position and the attitude of the speaker unit 3.

Note that, while the 6DoF sensor 32 may be provided anywhere as long as it can measure the position and the attitude of the head 11, it is preferably provided in the speaker unit 3. That is, the speaker unit 3 that includes the 6DoF sensor 32 for measuring the position of the head 11 and is worn on the ear of the user 10 to output a sound and the information processing unit 4 (wearable display device 1) are preferably configured in a connectable manner.

The display unit 2 and the speaker units 3 are connected to the information processing unit 4 via the cables 5. The information processing unit 4 integrally controls the entire wearable display device 1 as will be described in detail later.

On the basis of the control of the information processing unit 4, the display unit 2 causes light for forming a display image to be emitted to the eyeballs 12 of the user 10, transmits information regarding the position and the attitude of the display unit 2 (position/attitude information) measured by the 6DoF sensor 24 to the information processing unit 4, and outputs video imaged by the external recognition camera 25 to the information processing unit 4.

On the basis of the control of the information processing unit 4, the speaker units 3 output a sound and transmit the position/attitude information of the head 11 measured by the 6DoF sensor 32 to the information processing unit 4.

Note that, while the display unit 2 has been described to be the spectacle type as an example, it may be any type as long as the user 10 is allowed to visually recognize the virtual object. For example, the display unit 2 may cover the head, or may be a monocle type.

Furthermore, while the display unit 2 and the speaker units 3 have been described to be connected to the information processing unit 4 via the cables 5, they may be connected to the information processing unit 4 wirelessly. Furthermore, the information processing unit 4 may be fixed to the display unit 2, for example.

### [1.2 Optical Structure of Display Unit 2]

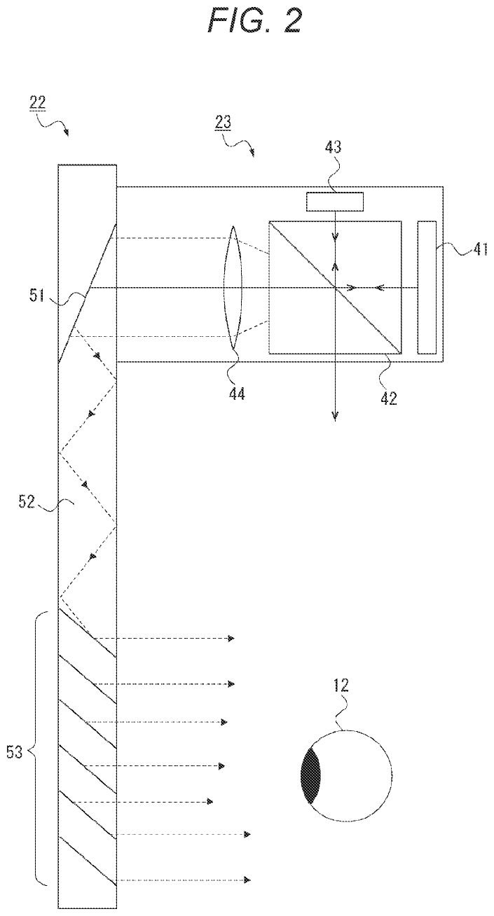

FIG. 2 is a diagram for explaining an optical structure of the display unit 2. Note that FIG. 2 illustrates only one side of the emission unit 22 and the image forming units 23 that emit light for forming a display image to each of the right and left eyeballs 12.

As illustrated in FIG. 2, the image forming unit 23 includes a liquid crystal display device 41, a polarizing beam splitter 42, a light source 43, and a collimating optical system 44.

The liquid crystal display device 41 is a display device in which a plurality of pixels is arranged in a two-dimensional matrix, and functions as a light valve. The polarizing beam splitter 42 is an optical member that allows a part of polarized light of the incident light to pass therethrough and reflects the remaining polarized light of the incident light. The light source 43 is a light source that emits unpolarized light such as a light emitting diode.

The unpolarized light emitted from the light source 43 first enters the polarizing beam splitter 42. Here, the p-polarized component of the light emitted from the light source 43 is emitted to the outside by passing through the polarizing beam splitter 42. On the other hand the s-polarized component of the light emitted from the light source 43 is reflected by the polarizing beam splitter 42, and is guided to the liquid crystal display device 41. The light incident on the liquid crystal display device 41 is reflected inside the liquid crystal display device 41, and is emitted from the liquid crystal display device 41.

The light emitted from the liquid crystal display device 41 is incident on the polarizing beam splitter 42. Here, of the light emitted from the liquid crystal display device 41, the light emitted from the pixels displaying white contains a large amount of p-polarized components, and thus passes through the polarizing beam splitter 42 to be emitted to the collimating optical system 44. On the other hand, since the light emitted from the pixels displaying black contains a large amount of s-polarized components, it is reflected by the polarizing beam splitter 42 to be returned to the light source 43.

The collimating optical system 44 converts the light incident from the polarizing beam splitter 42 into parallel light. The collimating optical system 44 may be configured by a convex lens, a concave lens, a free-form surface prism, or a hologram lens alone or in combination. The light having passed through the collimating optical system 44 and converted into the parallel light enters the emission unit 22.

The emission unit 22 includes a first deflection means 51, a light guide plate 52, and a second deflection means 53. The first deflection means 51 functions as a reflecting mirror by being configured by a light-reflecting film of one layer, for example. The light guide plate 52 is an optical member having two parallel planes extending in parallel with the axis of the light guide plate 52. The light guide plate 52 may include, for example, a transparent member, such as optical glass such as quartz glass, acrylic resin, polycarbonate resin, amorphous polypropylene resin, or the like. The second deflection means 53 includes, for example, a light reflecting multilayer film having a laminated structure, and functions as a semi-transmissive mirror.

The parallel light incident on the emission unit 22 from the collimating optical system 44 is reflected by the first deflection means 51, and then guided by being totally reflected between the two parallel planes of the light guide plate 52. The light guided by the light guide plate 52 is reflected by the second deflection means 53 a plurality of times, and is emitted from the light guide plate 52 to the eyeballs 12 of the user 10 in the state of the parallel light. Thus, the emission unit 22 and the image forming unit 23 cause the user 10 to visually recognize the display image displayed on the liquid crystal display device 41 as a virtual object.

Note that the emission unit 22 may include a lens such as a hologram lens. In a case where a lens such as a hologram lens is used as the emission unit 22, the emission unit 22 may emit light to the eyeballs 12 of the user 10 by polarizing the light with the lens.

As described above, since the display unit 2 includes the optical see-through emission unit 22, it allows the user 10 to visually recognize the real space through the emission unit 22, and also allows the user 10 to visually recognize the display image as a virtual object.

In other words, the display unit 2 is capable of providing the user 10 with augmented reality in which the virtual object is displayed in a manner of being superimposed on the real space.

Furthermore, the configuration illustrated in FIG. 2 is an example of implementing a device that emits light for forming a display image. The emission unit 22 and the image forming unit 23 may have any configuration as long as they can emit light for forming a display image.

### [1.3 Eye Box]

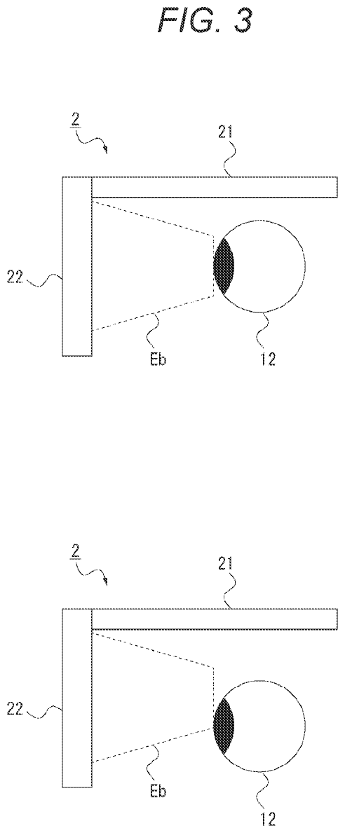

FIG. 3 is a diagram for explaining a relationship between the display unit 2 and an eye box Eb and the eyeball 12 of the user 10.

As illustrated in FIG. 3, in the display unit 2, the eye box Eb, which is a three-dimensional region in which the user 10 can visually recognize the entire display image (virtual object), is formed according to the characteristics of the light emitted from the emission unit 22. In a case where the eyeball 12 is present in the range of the eye box Eb, the user 10 is enabled to visually recognize the entire display image.

However, in a case where the eyeball 12 is out of the range of the eye box Eb, the user 10 is not enabled to visually recognize the display image at some angles of view as the eye box Eb is formed in a substantially conical shape from the emission unit 22.

For example, as illustrated in the lower part of FIG. 3, the relative position between the eye box Eb and the eyeball 12 of the user 10 changes in a case where the position of the display unit 2 with respect to the head 11 of the user 10 is shifted, that is, in a case where mounting deviation of the display unit 2 occurs. In a case where the mounting deviation occurs in this manner, there is a possibility that the user 10 is not enabled to visually recognize the display image at some angles of view.

Furthermore, even if the eyeball 12 is not out of the range of the eye box Eb when the mounting deviation occurs, positional deviation occurs between the object existing in the real space and the virtual object, which may cause what is called misaligned superimposition.

In view of the above, the wearable display device 1 is designed to detect presence or absence of the mounting deviation of the display unit 2, notify the user 10 of the occurrence of the mounting deviation in a case where the mounting deviation occurs, and execute a mounting deviation detection correction process for causing the user 10 to correct the mounting deviation.

Hereinafter, a functional configuration of the wearable display device 1 will be described first, and then the mounting deviation detection correction process mentioned above will be described.

### [1.4 Functional Configuration of Wearable Display Device 1]

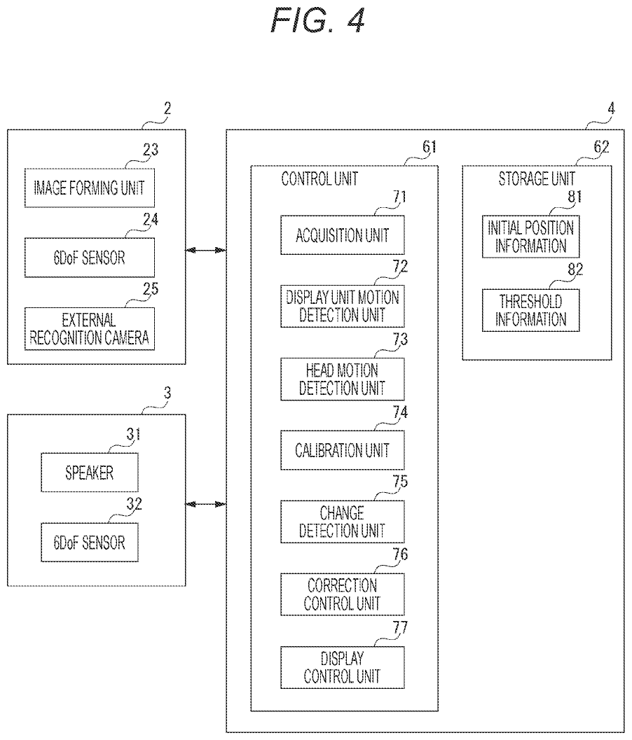

FIG. 4 is a diagram for explaining the functional configuration of the wearable display device 1. Note that, in FIG. 4, a part of the configurations of the display unit 2 and the speaker unit 3 is omitted to mainly describe a functional configuration of the information processing unit 4.

As illustrated in FIG. 4, the display unit 2 includes the image forming unit 23, the 6DoF sensor 24, and the external recognition camera 25. Furthermore, the speaker unit 3 includes the speaker 31 and the 6DoF sensor 32. Note that those configurations are as described above.

The information processing unit 4 includes a control unit 61 and a storage unit 62. The control unit 61 includes, for example, a computer including a central processing unit (CPU), a read only memory (ROM), and a random access memory (RAM), and takes overall control of the entire wearable display device 1. Furthermore, the control unit 61 reads and executes programs stored in the ROM (storage medium), thereby functioning as an acquisition unit 71, a display unit motion detection unit 72, a head motion detection unit 73, a calibration unit 74, a change detection unit 75, a correction control unit 76, and a display control unit 77.

The storage unit 62 includes a RAM or a non-volatile memory. The storage unit 62 stores initial position information 81 and threshold information 82 including a first threshold, a second threshold, and a third threshold, which will be described in detail later.

### <2. Mounting Deviation Detection Correction Process>

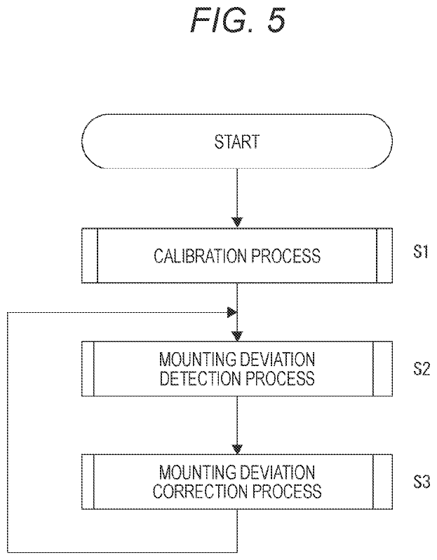

FIG. 5 is a flowchart illustrating a flow of the mounting deviation detection correction process. As illustrated in FIG. 5, when the wearable display device 1 is activated, the control unit 61 performs a calibration process for initially adjusting the position and the attitude of the display unit 2 and the speaker unit 3 in step S1. Then, the control unit 61 performs a mounting deviation detection process for detecting mounting deviation of the display unit 2 in step S2.

In a case where the mounting deviation of the display unit 2 is detected in step S2, the control unit 61 performs a mounting deviation correction process for causing the user 10 to correct the mounting deviation of the display unit 2 in step S3, and returns the process to step S2 when the mounting deviation of the display unit 2 is corrected.

Hereinafter, the calibration process, the mounting deviation detection process, and the mounting deviation correction process will be described in detail.

### [2.1 Calibration Process]

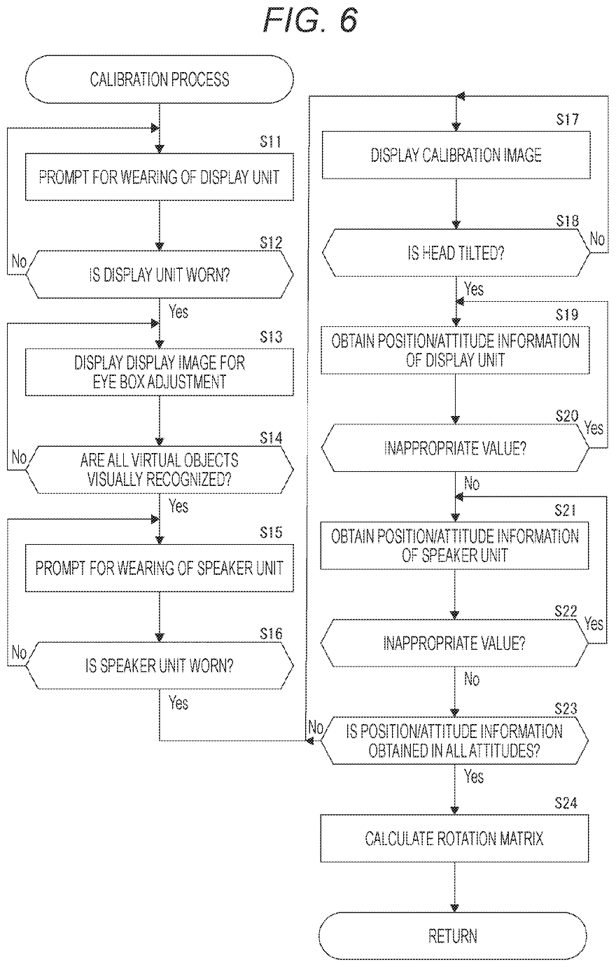

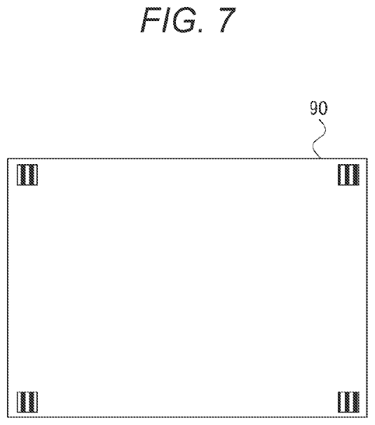

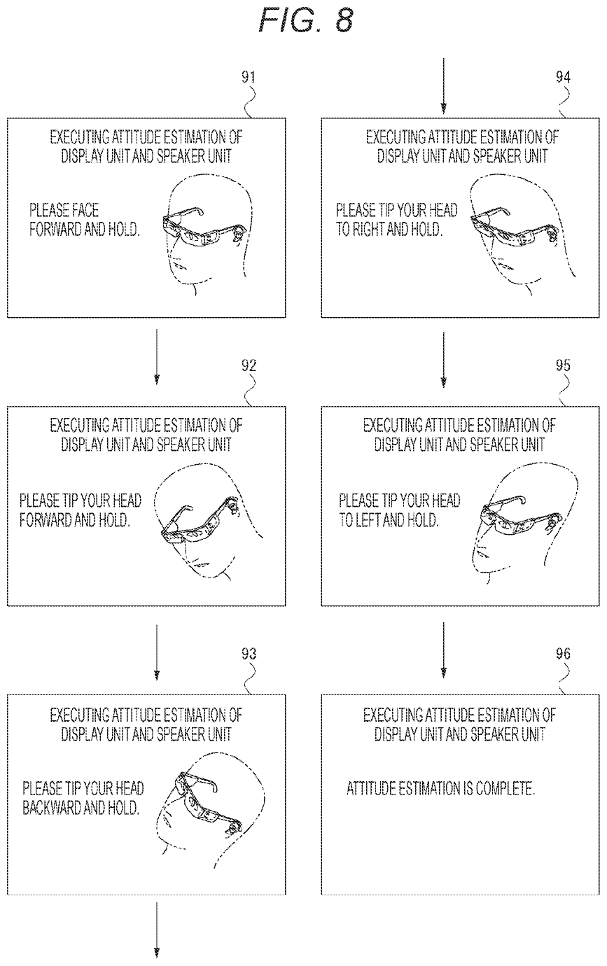

FIG. 6 is a flowchart illustrating a flow of the calibration process. FIG. 7 is a diagram for explaining a display image for eye box adjustment. FIG. 8 is a diagram for explaining a calibration image. As illustrated in FIG. 6, when the calibration process starts, the control unit 61 prompts the user 10 to wear the display unit 2 in step S11. Here, the control unit 61 may cause the speaker 31 of the speaker unit 3 to output a voice indicating that the display unit 2 is to be worn, or may make notification indicating that the display unit 2 is to be worn by another method.

Next, the control unit 61 determines whether the display unit 2 is worn by the user 10 in step S12. Here, the control unit 61 may make determination depending on whether or not an operation indicating that the display unit 2 is worn is performed by the user 10 through an operation unit (not illustrated), or may provide a contact sensor or the like to make determination on the basis of a detection result thereof, for example.

Then, in a case where the display unit 2 is not worn by the user 10 (No in step S12), the control unit 61 repeats steps S11 and S12 until the display unit 2 is worn by the user 10. On the other hand, in a case where the display unit 2 is worn by the user 10 (Yes in step S12), in step S13, the display control unit 77 causes the display unit 2 to display a display image 90 for eye box adjustment in which marks are attached at four corners, as illustrated in FIG. 7. With this arrangement, the user 10 is enabled to correct the position of the display unit 2 such that the four marks based on the display image 90 can be visually recognized as virtual objects.

Next, in step S14, the calibration unit 74 determines whether the user 10 is enabled to visually recognize all the virtual objects of the marks attached to the four corners of the display image 90. Here, it is determined whether the eyeballs 12 of the user 10 are present within the range of the eye box Eb described above, that is, whether the display unit 2 is properly worn by the user 10. Specifically, the calibration unit 74 make determination depending on whether or not the user has performed an operation indicating that the virtual objects of the marks attached to the four corners of the display image 90 can be visually recognized through an operation unit (not illustrated), for example.

Then, in a case where the user 10 fails to visually recognize the virtual objects of the marks attached to the four corners of the display image 90 (No in step S14), the display control unit 77 and the calibration unit 74 repeat steps S13 and S14 until the user 10 is enabled to visually recognize the virtual objects of the marks attached to the four corners of the display image 90.

On the other hand, in a case where the user 10 is enabled to visually recognize the virtual objects of the marks attached to the four corners of the display image 90 (Yes in step S14), the control unit 61 prompts the user 10 to wear the speaker units 3 in step S15. Here, the control unit 61 mat cause the display unit 2 to display a display image indicating that the speaker units 3 are to be worn, or may make notification indicating that the speaker units 3 are to be worn by another method.

Subsequently, in step S16, the control unit 61 determines whether the speaker units 3 are worn by the user 10. Here, the control unit 61 may make determination depending on whether or not an operation indicating that the speaker units 3 are worn is performed by the user through an operation unit (not illustrated), or may provide a contact sensor or the like to make determination on the basis of a detection result thereof, for example.

Then, in a case where the speaker units 3 are not worn by the user 10 (No in step S16), the control unit 61 repeats steps S15 and S16 until the speaker units 3 are worn by the user 10. On the other hand, in a case where the speaker units 3 are worn by the user 10 (Yes in step S16), the display control unit 77 causes the display unit 2 to display a calibration image as a display image for performing calibration at the time of startup in step S17. With this arrangement, the user 10 is caused to visually recognize the virtual object based on the calibration image.

Here, as illustrated in FIG. 8, five (calibration images 91 to 95) calibration images are provided to differentiate individual angles of the head 11 of the user 10. The calibration image 91 is an image for causing the user 10 to face forward. The calibration images 92 to 95 are images for causing the head 11 of the user 10 to tilt forward, backward, rightward, and leftward, respectively. In those calibration images 91 to 95, a direction along which the head 11 of the user 10 is to be tilted is indicated by characters and pictures.

The display control unit 77 first causes the display unit 2 to display the calibration image 91 for causing the user 10 to face forward.

Subsequently, in step S18, the calibration unit 74 determines whether the head 11 of the user 10 is oriented in the direction according to the calibration image. Here, the calibration unit 74 may make determination on the basis of a result of measurement measured by the 6DoF sensor 24 or the 6DoF sensor 32, for example, or may make determination by another method.

Then, in step S19, the acquisition unit 71 obtains position/attitude information of the display unit 2 measured by the 6DoF sensor 24. In step S20, the acquisition unit 71 determines whether or not the position/attitude information obtained in step S19 is an inappropriate value. Here, the position/attitude information obtained in step S19 is compared with the position/attitude information measured immediately before among the pieces of the position/attitude information continuously measured by the 6DoF sensor 24 due to noise or the like, and it is determined whether or not its value is different to the extent that the value is considered to be an inappropriate value due to noise or the like.

Then, in a case where the position/attitude information of the display unit 2 is an inappropriate value (Yes in step S20), the acquisition unit 71 repeats steps S19 and S20 until the position/attitude information is no longer an inappropriate value.

On the other hand, in a case where the position/attitude information of the display unit 2 is not an inappropriate value (No in step S20), the acquisition unit 71 obtains position/attitude information of the speaker unit 3 measured by the 6DoF sensor 32 in step S21. In step S22, the acquisition unit 71 determines whether or not the position/attitude information obtained in step S21 is an inappropriate value. Here, determination is made in a similar manner to step S20.

Then, in a case where the position/attitude information of the speaker unit 3 is an inappropriate value (Yes in step S21), the acquisition unit 71 repeats steps S21 and S22 until the position/attitude information is no longer an inappropriate value.

On the other hand, in a case where the position/attitude information of the speaker unit 3 is not an inappropriate value (No in step S22), the calibration unit 74 determines whether the position/attitude information in all the attitudes of the head 11 has been obtained in step S23. As a result, in a case where the position/attitude information in all the attitudes has not been obtained (No in step S23), the process returns to step S17, and the display control unit 77 causes the display unit 2 to display one of the next calibration images 92 to 95. Furthermore, the acquisition unit 71 and the calibration unit 74 execute the process of steps S18 to S22 to obtain the position/attitude information of the display unit 2 and the speaker unit 3.

In a case where the position/attitude information in all the attitudes has been obtained (Yes in step S23), in step S24, the calibration unit 74 calculates a rotation matrix R to be used for conversion from the x′y′z′ coordinate system to the xyz coordinate system on the basis of the position/attitude information obtained in steps S19 and S21.

Specifically, the calibration unit 74 calculates the rotation matrix R by substituting the position information of the position/attitude information of the display unit 2 and the speaker unit 3 when the head 11 of the user 10 is tilted forward, backward, rightward, and leftward into the following equation (1) for simultaneous calculation.

$$[ Equation 1 ]$$

$$( \begin{matrix}x \\ y \\ z\end{matrix} ) = ( \begin{matrix}{R}_{00} & {R}_{01} & {R}_{02} \\ {R}_{10} & {R}_{11} & {R}_{12} \\ {R}_{20} & {R}_{21} & {R}_{22}\end{matrix} ) ( \begin{matrix}{x}^{′} \\ {y}^{′} \\ {z}^{′}\end{matrix} ) \qquad ( 1 )$$

Note that the rotation matrix R is a 3×3 matrix on the first right side. Furthermore, at the time of calculating the rotation matrix R, it is sufficient if the position/attitude information in at least three different attitudes is obtained, and it is not necessary to obtain the position/attitude information in four different attitudes as described above. However, by obtaining the position/attitude information in more attitudes, it becomes possible to more accurately calculate the rotation matrix R.

Here, the rotation matrix R is used for conversion from the x′y′z′ coordinate system to the xyz coordinate system, and converts the position of the speaker unit 3 measured by the 6DoF sensor 32 into the xyz coordinate system, which is the coordinate system of the display unit 2 (6DoF sensor 24). Therefore, it can be said that the rotation matrix R represents a position/attitude relationship between the display unit 2 and the speaker unit 3 (head 11).

Thereafter, the calibration unit 74 causes the storage unit 62 to store the calculated rotation matrix R, and the display control unit 77 causes the display unit 2 to display a calibration image 96 notifying that the calibration process is terminated to end the calibration process (step S1).

### [2.2 Mounting Deviation Detection Process]

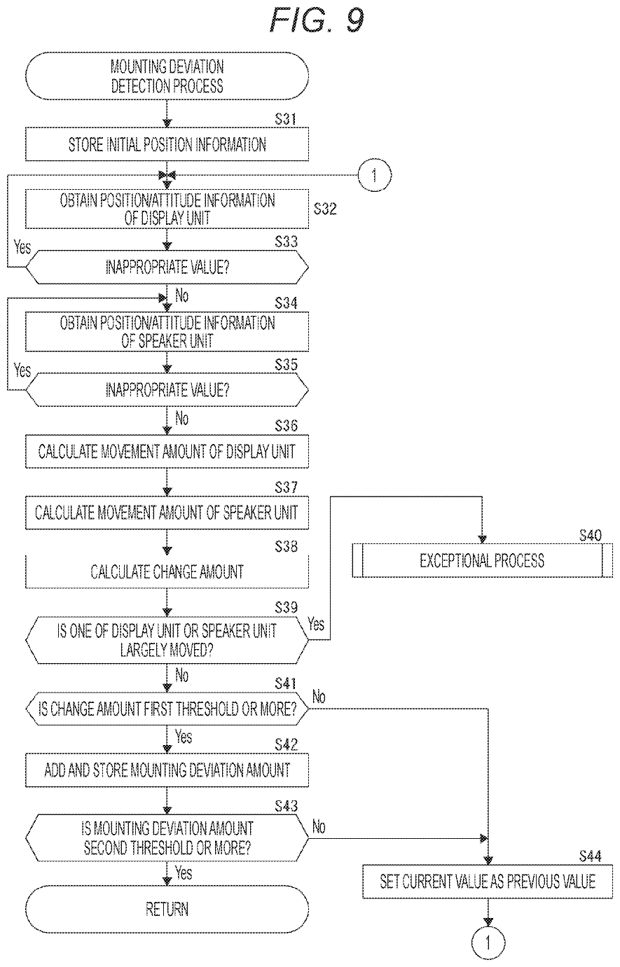

FIG. 9 is a flowchart illustrating a flow of the mounting deviation detection process. As illustrated in FIG. 9, when the mounting deviation detection process starts, the acquisition unit 71 obtains the position/attitude information measured by the 6DoF sensor 24 and the 6DoF sensor 32 in step S31. Then, the change detection unit 75 stores the obtained position/attitude information of the display unit 2 and the speaker unit 3 in the storage unit 62 as the initial position information 81.

In step S32, the acquisition unit 71 obtains the position/attitude information of the display unit 2 measured by the 6DoF sensor 24 at the current time tn. In step S33, the acquisition unit 71 determines whether or not the position/attitude information obtained in step S32 is an inappropriate value. Here, determination similar to that in step S20 is made.

Then, in a case where the position/attitude information is an inappropriate value (Yes in step S32), the acquisition unit 71 repeats steps S32 and S33 until the position/attitude information is no longer an inappropriate value.

On the other hand, in a case where the position/attitude information is not an inappropriate value (No in step S32), in step S34, the acquisition unit 71 obtains the position/attitude information of the speaker unit 3 measured by the 6DoF sensor 32 at the current time tn. In step S35, the acquisition unit 71 determines whether or not the position/attitude information obtained in step S34 is an inappropriate value. Here, determination similar to that in step S22 is made.

Then, in a case where the position/attitude information is an inappropriate value (Yes in step S35), the acquisition unit 71 repeats steps S34 and S35 until the position/attitude information is no longer an inappropriate value.

In a case where the position/attitude information is an inappropriate value (No in step S35), in step S36, the display unit motion detection unit 72 calculates (detects) a movement amount (motion) of the display unit 2 using the following equation (2).

$$[ Equation 2 ]$$

$$( \begin{matrix}{X}_{x , t n , hmd} \\ {X}_{y , t n , hmd} \\ {X}_{z , t n , hmd}\end{matrix} ) = \frac{1}{2} ( \begin{matrix}{a}_{x , t n , hmd} − {a}_{x , tn − 1 , hmd} \\ {a}_{y , t n , hmd} − {a}_{y , tn − 1 , hmd} \\ {a}_{z , t n , hmd} − {a}_{y , tn − , hmd}\end{matrix} ) {( {t}_{n} − {t}_{n − 1} )}^{2} \qquad ( 2 )$$

Note that a subscript n represents a current value, a subscript n-1 represents a previous value, a subscript x represents an x-axis direction, a subscript y represents a y-axis direction, a subscript z represents a z-axis direction, a subscript hmd represents the display unit 2, and a subscript t represents time. In addition, X represents a movement amount, and a represents a position of the display unit 2.

Thus, the matrix on the left side in the equation (2) indicates the respective movement amounts in the x-axis direction, y-axis direction, and z-axis direction in which the display unit 2 has moved from the previous time to this time. In addition, the matrix on the right side subtracts the respective previous positions from the current positions in the x-axis direction, y-axis direction, and z-axis direction for the display unit 2. In addition, in the parentheses on the right side, the previous time is subtracted from the current time.

Subsequently, in step S37, the head motion detection unit 73 converts the position of the speaker unit 3 indicated by the x′y′z′ coordinate system into a position of the xyz coordinate system using the following equation (3).

$$[ Equation 3 ]$$

$$( \begin{matrix}{a}_{x , tn , ear} \\ {a}_{y , tn , ear} \\ {a}_{z , tn , ear}\end{matrix} ) = ( \begin{matrix}{R}_{00} & {R}_{01} & {R}_{02} \\ {R}_{10} & {R}_{11} & {R}_{12} \\ {R}_{20} & {R}_{21} & {R}_{22}\end{matrix} ) ( \begin{matrix}{a}_{x ′ , tn , ear} \\ {a}_{y ′ tn , ear} \\ {a}_{z ′ , tn , ear}\end{matrix} ) \qquad ( 3 )$$

Note that a subscript x′ represents an x′-axis direction, a subscript y′ represents a y′-axis direction, a subscript z represents a z′-axis direction, and a subscript ear represents the speaker unit 3. In addition, the matrix on the left side indicates the position of the speaker unit 3 in the xyz coordinate system at the time tn, and the second matrix on the right side indicates the position of the speaker unit 3 in the x′y′z′ coordinate system at the time tn.

Then, the head motion detection unit 73 calculates a movement amount (motion) of the speaker unit 3 using the following equation (4). Since the speaker unit 3 moves integrally with the head 11 of the user 10, here, the head motion detection unit 73 calculates the movement of the speaker unit 3, thereby detecting the movement of the head 11.

$$[ Equation 4 ]$$

$$( \begin{matrix}{X}_{x , t n , ear} \\ {X}_{y , t n , ear} \\ {X}_{z , t n , ear}\end{matrix} ) = \frac{1}{2} ( \begin{matrix}{a}_{x , t n , ear} − {a}_{x , t n − 1 , ear} \\ {a}_{y , t n , ear} − {a}_{y , t n − 1 , ear} \\ {a}_{z , t n , ear} − {a}_{y , t n − , ear}\end{matrix} ) {( {t}_{n} − {t}_{n − 1} )}^{2} \qquad ( 4 )$$

The matrix on the left side in the equation (4) indicates the respective movement amounts in the x-axis direction, y-axis direction, and z-axis direction in which the speaker unit 3 has moved from the previous time to this time. In addition, the matrix on the right side subtracts the respective previous positions from the current positions in the x-axis direction, y-axis direction, and z-axis direction for the speaker unit 3. In addition, in the parentheses on the right side, the previous time is subtracted from the current time.

In step S38, the change detection unit 75 calculates, using the following equation (5), a change amount D of the position of the display unit 2 based on the speaker unit 3 from the previous time to this time on the basis of the movement amount of the display unit 2 and the movement amount of the speaker unit 3.

$$[ Equation 5 ]$$

$$D = \vert {X}_{tn , hmd} - {X}_{tn , ear} \vert \qquad ( 5 )$$

According to the equation (5), a difference between the movement amount of the display unit 2 and the movement amount of the speaker unit 3 (head 11) is calculated as the change amount D, thereby calculating how much the display unit 2 has relatively moved from the previous time to this time with reference to the speaker unit 3. That is, the change detection unit 75 compares the detection result of the movement of the display unit 2 with the detection result of the movement of the head 11 of the user 10, thereby detecting a change in the wearing state of the display unit 2. Furthermore, it can also be said that the detection result of the movement of the display unit 2 includes the calculation result of the movement amount of the display unit 2, and the detection result of the movement of the head 11 includes the calculation result of the movement amount of the head 11.

In step S39, the change detection unit 75 determines whether only one of the display unit 2 or the speaker unit 3 calculated using the equations (3) and (4) has largely moved. Here, it is determined whether the difference between the movement amount of the display unit 2 and the movement amount of the speaker unit 3 is equal to or more than a predetermined amount. With this arrangement, it becomes possible to determine whether one of the display unit 2 or the speaker unit 3 is detached from the head 11 of the user 10. Note that the predetermined amount is set to a value with which determination on whether one of the display unit 2 or the speaker unit 3 is detached from the head 11 can be made.

Then, in a case where only one of the display unit 2 or the speaker unit 3 has largely moved (Yes in step S39), the change detection unit 75 executes an exceptional process in step S40. Note that the exceptional process will be described later.

On the other hand, in a case where only one of the display unit 2 or the speaker unit 3 has not largely moved (No in step S39), the change detection unit 75 determines whether the change amount D is equal to or larger than the first threshold in step S41. Here, the first threshold is set to a value for excluding the change amount D calculated due to a measurement error of the 6DoF sensor 24 and the 6DoF sensor 32, and is set to 1 mm, for example.

In a case where the change amount D is equal to or larger than the first threshold (Yes in step S41), the change detection unit 75 adds the change amount D to a mounting deviation amount in step S42. Note that the mounting deviation amount is set to 0 in the initial state, and is integrated as needed in step S42 in the case where the change amount D is equal to or larger than the first threshold. Therefore, the change detection unit 75 calculates the mounting deviation amount of the display unit 2 on the basis of the calculation result of the movement amount of the display unit 2 and the calculation result of the movement amount of the speaker unit 3.

Then, in step S43, the change detection unit 75 determines whether the mounting deviation amount is equal to or larger than the second threshold. Here, the second threshold, which is larger than the first threshold, is set to a value at which the eyeball 12 is out of the eye box Eb and the eyeball 12 of the user 10 becomes unable to be irradiated with the entire display image. For example, in a case where the eye box is 9 mm×6 mm, it is set to a half value of the short side (3 mm).

In a case where the mounting deviation amount is equal to or larger than the second threshold (Yes in step S43), the change detection unit 75 determines occurrence of the mounting deviation of the display unit 2, and the process is shifted to the mounting deviation correction process (step S3).

On the other hand, in a case where the change amount D is not equal to or larger than the first threshold (No in step S41) and in a case where the mounting deviation amount is not equal to or larger than the second threshold (No in step S43), the change detection unit 75 determines that almost no mounting deviation of the display unit 2 occurs and the eyeball 12 is not out of the eye box Eb. In this case, in step S44, the change detection unit 75 sets various current values as various previous values, and returns to the processing of step S32.

Note that, in the case where the change amount D is not equal to or larger than the first threshold (No in step S43), the process proceeds to step S44 without adding the calculated change amount D to the mounting deviation amount. That is, in the case where the change amount D is not equal to or larger than the first threshold (No in step S43), the calculated change amount D is abandoned.

### [2.3 Exceptional Process]

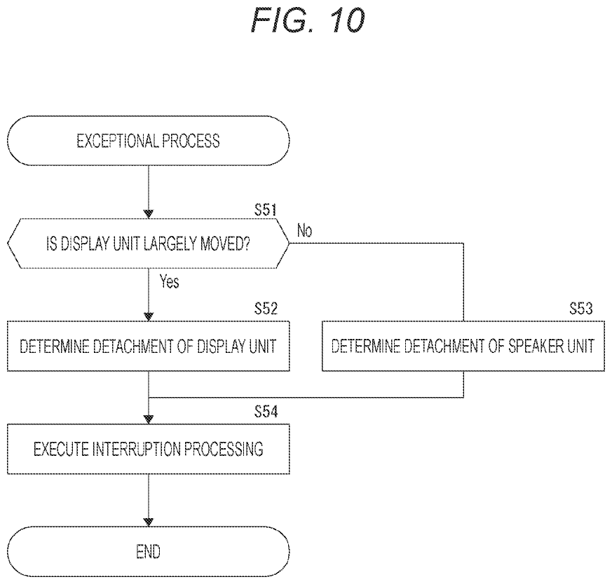

FIG. 10 is a flowchart illustrating a flow of the exceptional process. As illustrated in FIG. 10, when the exceptional process starts, the change detection unit 75 determines whether the movement amount of the display unit 2 is large in step S51. Here, it is determined whether the display unit 2 has moved by equal to or more than a predetermined amount as compared with the speaker unit 3 (head 11).

In a case where the movement amount of the display unit 2 is large as a result thereof (Yes in step S51), the change detection unit 75 determines that the display unit 2 is detached from the head 11 of the user 10 in step S52. Furthermore, in a case where the movement amount of the display unit 2 is not large (No in step S51), that is, in a case where the speaker unit 3 (head 11) has moved by equal to or more than a predetermined amount as compared with the display unit 2, the change detection unit 75 determines that the speaker unit 3 is detached from the head 11 of the user 10 in step S53.

When the detachment of the display unit 2 or the speaker unit 3 is detected in this manner, in step S54, the change detection unit 75 stops the display of the display image on the display unit 2 and the output of the sound from the speaker unit 3, executes interruption processing, such as power-off, and terminates the mounting deviation detection correction process.

### [2.4 Specific Example of Mounting Deviation Detection Process]

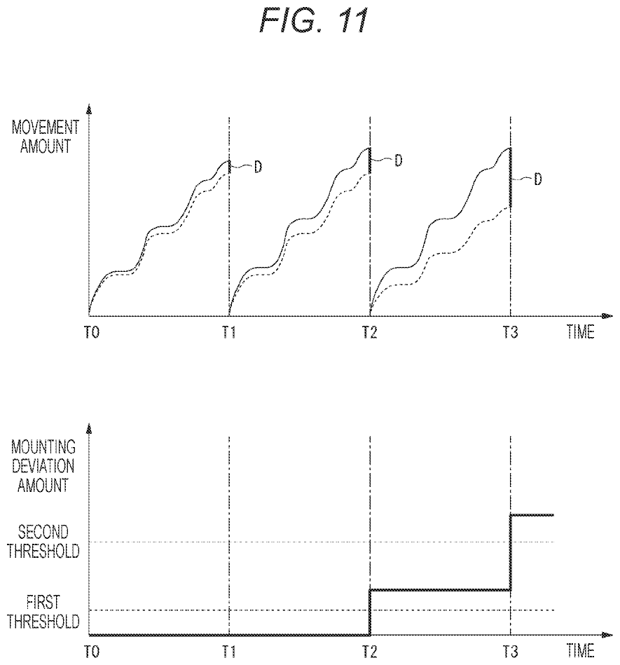

FIG. 11 is a diagram for explaining a specific example of the mounting deviation detection process. As illustrated in FIG. 11, since the display unit 2 and the speaker unit 3 of the wearable display device 1 are worn on the head 11 of the user 10, the display unit 2 and the speaker unit 3 move together with the head 11 of the user 10 in a case of being normally used, and the movement amounts of the display unit 2 and the speaker unit 3 are the same.

However, when the user 10 moves vigorously so that the relative position between the display unit 2 and the head 11 is shifted to cause mounting deviation of the display unit 2, for example, the movement amounts of the display unit 2 and the speaker unit 3 become different.

For example, it is assumed that the mounting deviation detection process starts at time TO. Then, it is assumed that the change amount D is smaller than the first threshold at time T1 after a time ΔT. In this case, the change detection unit 75 does not execute the processing of step S42, and thus no mounting deviation amount is added and the change amount D is abandoned. Furthermore, in step S44, the current position information is set as the previous position information, and the change amount D is reset to 0.

Thereafter, it is assumed that the change amount D is equal to or larger than the first threshold and smaller than the second threshold at time T2 after the time ΔT. In this case, while the change detection unit 75 adds the change amount D to the mounting deviation amount in the processing of step S42, the mounting deviation amount is smaller than the second threshold. Furthermore, in step S44, the current position information is set as the previous position information, and the change amount D is reset to 0.

Thereafter, it is assumed that, at time T3 after the time ΔT, the change amount D is equal to or larger than the first threshold and the mounting deviation amount when the change amount D is added thereto is equal to or larger than the second threshold. Then, since the mounting deviation amount is equal to or larger than the second threshold, the mounting deviation correction process is executed.

### [2.4 Mounting Deviation Correction Process]

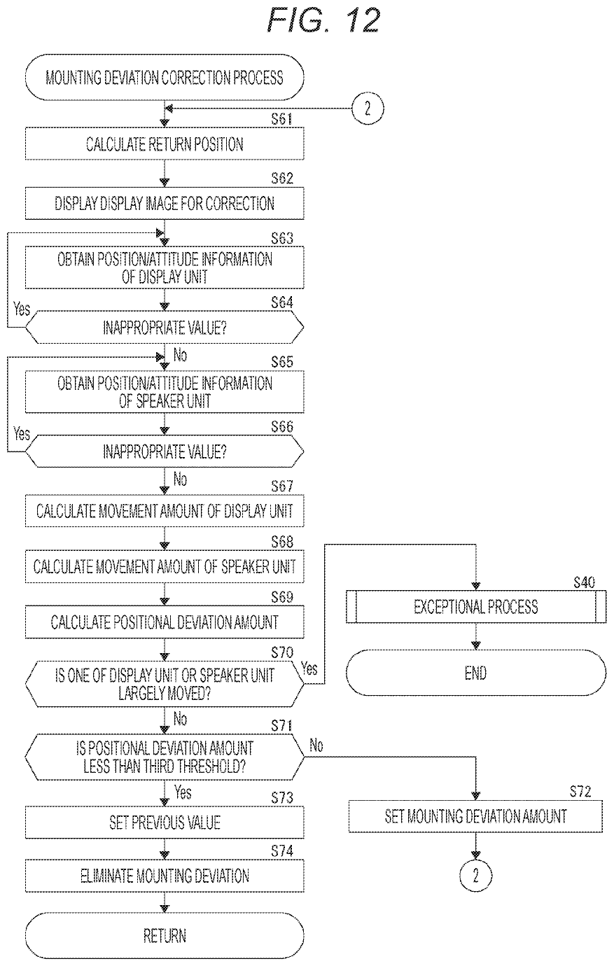

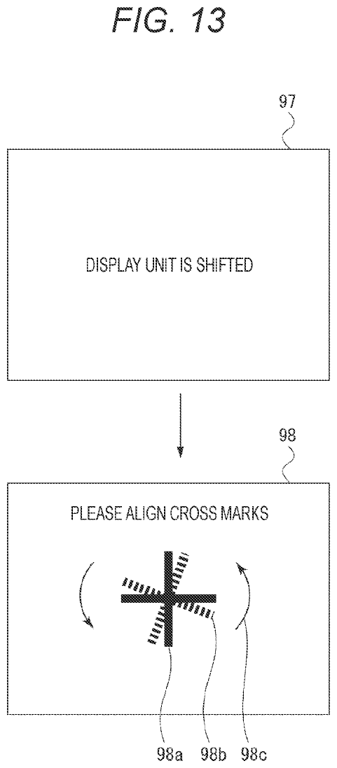

FIG. 12 is a diagram for explaining the mounting deviation correction process. FIG. 13 is a diagram for explaining a display image displayed in the mounting deviation correction process.

As illustrated in FIG. 12, in step S61, the correction control unit 76 calculates a return position for restoring the relative positional relationship between the display unit 2 and the speaker unit 3 to the initial state. For example, as a calculation method, it is sufficient if the return position is calculated on the basis of the mounting deviation amount. That is, it is sufficient if the calculation is executed on the basis of the relative positional relationship between the display unit 2 and the speaker unit 3 before the mounting deviation occurs and the relative positional relationship between the display unit 2 and the speaker unit 3 when the mounting deviation occurs. Here, it is only required to calculate the return position for restoring the relative positional relationship between the display unit 2 and the speaker unit 3 to the initial state (state before the occurrence of the mounting deviation).

Then, in step S62, the correction control unit 76 and the display control unit 77 first cause the display unit 2 to display a display image 97 making notification of mounting deviation of the display unit 2, as illustrated in FIG. 13. Here, it can be said that the correction control unit 76 and the display control unit 77 make notification of a change in the wearing state of the display unit 2.

Thereafter, the correction control unit 76 and the display control unit 77 causes the display unit 2 to display a display image 98 for causing the mounting deviation of the display unit 2 to be corrected.

Here, the display image 98 is provided with two cross marks 98a and 98b. The cross mark 98a is a cross mark drawn by straight lines along the longitudinal direction and the lateral direction of the display image 98, and is present at the center of the display image 98 at all times. In addition, the cross mark 98b is a cross mark corresponding to the return position calculated in step S61, and is present in a state of being shifted according to the return position with reference to the center of the display image 98.

Furthermore, in the display image 98, in addition to the presentation of the cross mark 98a serving as a reference and the cross mark 98b according to the return position, indication of alignment of the two cross marks 98a and 98b and a direction arrow 98c making notification of a direction and an amount of movement (direction of correcting the mounting deviation) by the arrow direction and size are present.

With this arrangement, the user 10 is enabled to intuitively grasp the fact that the mounting deviation of the display unit 2 can be corrected by aligning the two cross marks 98a and 98b.

Thereafter, in step S63, the acquisition unit 71 obtains the position/attitude information of the display unit 2 measured by the 6DoF sensor 24. In step S64, the acquisition unit 71 determines whether or not the position/attitude information obtained in step S63 is an inappropriate value. Here, determination similar to that in step S20 is made.

Then, in a case where the position/attitude information is an inappropriate value (Yes in step S64), the acquisition unit 71 repeats steps S63 and S64 until the position/attitude information is no longer an inappropriate value.

On the other hand, in a case where the position/attitude information is not an inappropriate value (No in step S64), the acquisition unit 71 obtains the position/attitude information of the speaker unit 3 measured by the 6DoF sensor 32 in step S65. In step S66, the acquisition unit 71 determines whether or not the position/attitude information obtained in step S65 is an inappropriate value. Here, determination similar to that in step S22 is made.

Then, in a case where the position/attitude information is an inappropriate value (Yes in step S66), the acquisition unit 71 repeats steps S65 and S66 until the position/attitude information is no longer an inappropriate value.

In a case where the position/attitude information is not an inappropriate value (No in step S66), in step S67, the display unit motion detection unit 72 calculates a movement amount of the display unit 2 using the equation (2) described above.

In step S68, the head motion detection unit 73 converts the position of the speaker unit 3 indicated by the x′y′z′ coordinate system into a position of the xyz coordinate system using the equation (3) described above. Furthermore, the head motion detection unit 73 calculates a movement amount of the speaker unit 3 using the equation (4) described above.

In step S69, the correction control unit 76 calculates, as a change amount, a difference between the movement amount of the display unit 2 and the movement amount of the speaker unit 3. Furthermore, the correction control unit 76 adds the change amount to the mounting deviation amount, and calculates a positional deviation amount, which is a deviation amount between the current position of the display unit 2 and the return position, on the basis of the mounting deviation amount and the return position.

In step S70, the correction control unit 76 determines whether only one of the display unit 2 or the speaker unit 3 has largely moved on the basis of the movement amount calculated using the equations (3) and (4).

Then, in a case where only one of the display unit 2 or the speaker unit 3 has largely moved (Yes in step S70), the change detection unit 75 executes the exceptional process in step S40.

On the other hand, in a case where only one of the display unit 2 or the speaker unit 3 has not largely moved (No in step S70), the change detection unit 75 determines whether the positional deviation amount is equal to or smaller than the third threshold in step S71. Here, the third threshold is set to a value at which the mounting deviation of the display unit 2 is considered to be corrected, and is set to 1 mm, for example.

In a case where the positional deviation amount is not equal to or smaller than the third threshold (No in step S71), the change detection unit 75 sets the current positional deviation amount as the mounting deviation amount in step S72, and returns to the processing of step S61.

On the other hand, in a case where the positional deviation amount is equal to or smaller than the third threshold (Yes in step S71), the change detection unit 75 sets the various values of this time as various values of the previous time in step S73. Furthermore, in step S74, the display control unit 77 causes the display unit 2 to display a display image indicating that the mounting deviation has been eliminated, and returns to the process of the mounting deviation detection process (step S2).

### <3. Variations>

Note that the embodiment is not limited to the specific examples described above, and configurations as various modifications may be adopted.

For example, at the time of calculating the movement amounts of the display unit 2 and the speaker unit 3, the position of the speaker unit 3 is converted into the xyz coordinate system, which is a coordinate system of the display unit 2. However, the position of the display unit 2 may be converted into the x′y′z′ coordinate system, which is a coordinate system of the speaker unit 3.

Thus, the calibration unit 74 is only required to calculate a rotation matrix to be used for conversion from one coordinate system of the xyz coordinate system (first coordinate system) or the x′y′z′ coordinate system (second coordinate system) to the other coordinate system.

Furthermore, the case where the display unit 2 is an optical see-through display has been described. However, the display unit 2 may be, as long as it is a display that emits light for forming a display image from the emission unit 22, a retinal projection display that directly projects light for forming a display image onto the eyeballs 12 by scanning laser light, for example.

Furthermore, the method of detecting the mounting deviation of the display unit 2, that is, the change in the wearing state of the display unit 2 (mounting deviation detection process) is an example, and another method may be used as long as the change in the wearing state of the display unit 2 can be detected by comparing the movement of the display unit 2 with the movement of the head 11 of the user 10.

Furthermore, the mounting deviation correction process is an example, and may be performed by another method as long as the occurrence of the mounting deviation can be notified and the mounting deviation of the display unit 2 can be corrected.

### <4. Summary of Embodiment>

As described above, the wearable display device 1 according to the embodiment includes the change detection unit 75 that detects a change in the wearing state of the display unit 2, which is worn on the head 11 of the user 10 and emits light for forming a display image to the eyeballs 12 of the user 10, by comparing a detection result of movement of the display unit 2 and a detection result of movement of the head 11.

With this arrangement, the wearable display device 1 is enabled to detect the change in the wearing state of the display unit 2 only by adopting a structure for measuring information required to detect the movement of the display unit 2 and the movement of the head 11, that is, only by including the 6DoF sensor 24 and the 6DoF sensor 32. Here, since the 6DoF sensor 24 is a sensor necessary for achieving AR technology, it is only required to substantially add the 6DoF sensor 32.

Thus, the wearable display device 1 is enabled to reduce restrictions on the structure.

Furthermore, it is conceivable that the detection result of the movement of the display unit 2 includes a calculation result of a movement amount of the display unit 2, the detection result of the movement of the head 11 includes a calculation result of a movement amount of the head 11, and the change detection unit 75 calculates a mounting deviation amount of the display unit 2 on the basis of the movement amount of the display unit 2 and the movement amount of the head 11.

With this arrangement, the wearable display device 1 is enabled to calculate the mounting deviation amount of the display unit 2 with a structure for calculating each of the movement amount of the display unit 2 and the movement amount of the head 11.

Thus, the wearable display device 1 is enabled to further reduce the restrictions on the structure.

Furthermore, it is conceivable that the change detection unit 75 calculates a difference between the movement amount of the display unit 2 and the movement amount of the head 11 as a change amount, and adds the change amount to the mounting deviation amount in a case where the change amount is equal to or larger than the first threshold.

With this arrangement, when the change amount becomes a value smaller than the first threshold due to noise or the like while the relative positional relationship between the display unit 2 and the head 11 does not actually change, the change amount does not need to be added to the mounting deviation amount.

Thus, it becomes possible to accurately calculate the mounting deviation amount.

Furthermore, it is conceivable that the change detection unit 75 determines occurrence of mounting deviation of the display unit in a case where the mounting deviation amount is equal to or larger than the second threshold.

With this arrangement, it becomes possible to grasp a situation where the user 10 fails to visually recognize a part of the virtual object or the virtual object is shifted with respect to the real space.

Furthermore, it is conceivable to include the correction control unit 76 that makes notification of the change in the wearing state of the display unit 2.

With this arrangement, it becomes possible to cause the user 10 to recognize the mounting deviation when the mounting deviation of the display unit 2 occurs.

Furthermore, it is conceivable that the correction control unit 76 makes notification that prompts for correction of the mounting deviation of the display unit 2 in a case where the mounting deviation of the display unit 2 is determined.

With this arrangement, it becomes possible to cause the user 10 to correct the mounting deviation of the display unit 2.

Furthermore, it is conceivable that the correction control unit 76 makes notification of the direction of correcting the mounting deviation.

With this arrangement, it becomes possible to allow the user 10 to easily correct the mounting deviation.

Furthermore, it is conceivable to include the calibration unit 74 that calibrates the positional relationship between the display unit 2 and the head 11 on the basis of the positions of the display unit 2 and the head 11 in a plurality of attitudes of the head 11.

With this arrangement, it becomes possible to grasp the position/attitude relationship between the display unit 2 and the head 11 measured by the 6DoF sensor 24 and the 6DoF sensor 32 arranged at different positions.

It is conceivable that the calibration unit 74 calculates the rotation matrix R to be used for conversion from one coordinate system of the first coordinate system (xyz coordinate system) in which the position of the display unit 2 is measured or the second coordinate system (x′y′z′ coordinate system) in which the position of the head 11 is measured to the other coordinate system.

With this arrangement, it becomes possible to represent the position/attitude relationship between the display unit 2 and the head 11 with the rotation matrix R.

It is conceivable that the display unit 2 includes a transmissive display.

With this arrangement, since the wearable display device 1 is capable of achieving the AR technology that superimposes a virtual object on the real world to be visually recognized, it is particularly useful to detect the change in the wearing state of the display unit 2.

Furthermore, it is conceivable to adopt a configuration connectable to the speaker unit 3 that includes a sensor (6DoF sensor 32) for measuring the position of the head 11 and is worn on the ear of the user to output a sound.

With this arrangement, it becomes possible to measure the position and attitude of the head 11 with the 6DoF sensor 32 provided in the speaker unit 3. In particular, since the speaker unit 3 is also provided in the normal wearable display device 1, it becomes possible to detect the change in the wearing state of the display unit 2 only by a change of adding the 6DoF sensor 32 to the speaker unit 3.

It is conceivable that the change detection unit 75 determines that the display unit 2 is detached from the head 11 in a case where the display unit 2 moves by equal to or more than a predetermined amount as compared with the head 11.

With this arrangement, it becomes possible to reduce erroneous detection of the mounting deviation of the display unit 2 when the display unit 2 is detached from the head 11.

It is conceivable that the change detection unit 75 determines that the speaker unit 3 is detached from the head 11 in a case where the head 11 moves equal to or more than a predetermined amount as compared with the display unit 2.

With this arrangement, it becomes possible to reduce erroneous detection of the mounting deviation of the display unit 2 when the speaker unit 3 is detached from the head 11.

Furthermore, the wearable display device 1 according to the embodiment detects a change in the wearing state of the display unit 2, which is worn on the head 11 of the user 10 and emits light for forming a display image to the eyeballs 12 of the user 10, by comparing a detection result of movement of the display unit 2 and a detection result of movement of the head 11.

Furthermore, a recording medium records a program that causes a computer to function as the change detection unit 75 that detects a change in the wearing state of the display unit 2, which is worn on the head 11 of the user 10 and emits light for forming a display image to the eyeballs 12 of the user 10, by comparing a detection result of movement of the display unit 2 and a detection result of movement of the head 11.

Such a program may be recorded in advance in a hard disk drive (HDD) as a recording medium built in a device such as a computer device, a ROM in a microcomputer having a CPU, or the like.

Alternatively, it may be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, a memory card, or the like. Such a removable recording medium may be provided as what is called package software.

Furthermore, such a program may be installed from the removable recording medium into a personal computer or the like, or may be downloaded from a download site via a network such as a local area network (LAN), the Internet, or the like.

Note that the effects described in the present specification are merely examples and are not limited, and other effects may be exerted.

### <5. Present Technology>

The present technology may also adopt the following configurations.

(1)

A wearable display device including:
a change detection unit that detects a change in a wearing state of a display unit, which is worn on a head of a user and emits light for forming a display image to an eyeball of the user, by comparing a detection result of movement of the display unit and a detection result of movement of the head.
   (2)

The wearable display device according to (1), in which
the detection result of the movement of the display unit includes a calculation result of a movement amount of the display unit,
the detection result of the movement of the head includes a calculation result of a movement amount of the head, and
the change detection unit is configured to:
calculate a mounting deviation amount of the display unit on the basis of the movement amount of the display unit and the movement amount of the head.
   (3)

The wearable display device according to (2), in which
the change detection unit is configured to:
calculate a difference between the movement amount of the display unit and the movement amount of the head as a change amount, and add the change amount to the mounting deviation amount in a case where the change amount is equal to or larger than a first threshold.
   (4)

The wearable display device according to (2) or (3), in which
the change detection unit is configured to:
determine occurrence of mounting deviation of the display unit in a case where the mounting deviation amount is equal to or larger than a second threshold.
   (5)

The wearable display device according to any one of (1) to (4), further including:
a correction control unit that makes notification of the change in the wearing state of the display unit.
   (6)

The wearable display device according to (5), in which
the correction control unit is configured to:
make notification that prompts for correction of mounting deviation of the display unit in a case where occurrence of the mounting deviation of the display unit is determined.
   (7)

The wearable display device according to (6), in which
the correction control unit is configured to:
make notification of a direction in which the mounting deviation is to be corrected.
   (8)

The wearable display device according to any one of (1) to (7), further including:
a calibration unit that calibrates a position and attitude relationship between the display unit and the head on the basis of positions of the display unit and the head in a plurality of attitudes of the head.
   (9)

The wearable display device according to (8), in which
the calibration unit is configured to:
calculate a rotation matrix to be used for conversion from one coordinate system of a first coordinate system in which the position of the display unit is measured or a second coordinate system in which the position of the head is measured to the other coordinate system.
   (10)

The wearable display device according to any one of (1) to (9), in which
the display unit includes a transmissive display.
   (11)

The wearable display device according to any one of (1) to (10), in which
the wearable display device is connectable to a speaker unit that includes a sensor for measuring a position of the head and is worn on an ear of the user to output a sound.
   (12)

The wearable display device according to any one of (1) to (11), in which
the change detection unit is configured to:
determine that the display unit is detached from the head in a case where the display unit moves by equal to or more than a predetermined amount as compared with the head.
   (13)

The wearable display device according to (11), in which
the change detection unit is configured to:
determine that the speaker unit is detached from the head in a case where the head moves by equal to or more than a predetermined amount as compared with the display unit.
   (14)

A detection method including:
detecting a change in a wearing state of a display unit, which is worn on a head of a user and emits light for forming a display image to an eyeball of the user, by comparing a detection result of movement of the display unit and a detection result of movement of the head.
   (15)

A recording medium recording a program that causes a computer to function as:
a change detection unit that detects a change in a wearing state of a display unit, which is worn on a head of a user and emits light for forming a display image to an eyeball of the user, by comparing a detection result of movement of the display unit and a detection result of movement of the head.

### REFERENCE SIGNS LIST

1 Wearable display device
2 Display unit
3 Speaker unit
24 6DOF sensor
32 6DoF sensor
61 Control unit
72 Display unit motion detection unit
73 Head motion detection unit
75 Change detection unit

1. A wearable display device comprising:
a change detection unit that detects a change in a wearing state of a display unit that is worn on a head of a user and emits light that forms a display image to an eyeball of the user by comparing a detection result of movement of the display unit and a detection result of movement of the head.

2. The wearable display device according to claim 1, wherein
the detection result of the movement of the display unit includes a calculation result of a movement amount of the display unit,
the detection result of the movement of the head includes a calculation result of a movement amount of the head, and
the change detection unit is configured to:
calculate a mounting deviation amount of the display unit on a basis of the movement amount of the display unit and the movement amount of the head.

3. The wearable display device according to claim 2, wherein
the change detection unit is configured to:
calculate a difference between the movement amount of the display unit and the movement amount of the head as a change amount, and add the change amount to the mounting deviation amount in a case where the change amount is equal to or larger than a first threshold.

4. The wearable display device according to claim 2, wherein
the change detection unit is configured to:
determine occurrence of mounting deviation of the display unit in a case where the mounting deviation amount is equal to or larger than a second threshold.

5. The wearable display device according to claim 1, further comprising:
a correction control unit that makes notification of the change in the wearing state of the display unit.

6. The wearable display device according to claim 5, wherein
the correction control unit is configured to:
make notification that prompts for correction of mounting deviation of the display unit in a case where occurrence of the mounting deviation of the display unit is determined.

7. The wearable display device according to claim 6, wherein
the correction control unit is configured to:
make notification of a direction in which the mounting deviation is to be corrected.

8. The wearable display device according to claim 1, further comprising:
a calibration unit that calibrates a position and attitude relationship between the display unit and the head on a basis of positions of the display unit and the head in a plurality of attitudes of the head.

9. The wearable display device according to claim 8, wherein
the calibration unit is configured to:
calculate a rotation matrix to be used for conversion from one coordinate system of a first coordinate system in which the position of the display unit is measured or a second coordinate system in which the position of the head is measured to another coordinate system.

10. The wearable display device according to claim 1, wherein
the display unit includes a transmissive display.

11. The wearable display device according to claim 1, wherein
the wearable display device is connectable to a speaker unit that includes a sensor that measures a position of the head and is worn on an ear of the user to output a sound.

12. The wearable display device according to claim 1, wherein
the change detection unit is configured to:
determine that the display unit is detached from the head in a case where the display unit moves by equal to or more than a predetermined amount as compared with the head.

13. The wearable display device according to claim 11, wherein
the change detection unit is configured to:
determine that the speaker unit is detached from the head in a case where the head moves by equal to or more than a predetermined amount as compared with the display unit.

14. A detection method comprising:
detecting a change in a wearing state of a display unit that is worn on a head of a user and emits light that forms a display image to an eyeball of the user by comparing a detection result of movement of the display unit and a detection result of movement of the head.

15. A recording medium recording a program that causes a computer to function as:
a change detection unit that detects a change in a wearing state of a display unit that is worn on a head of a user and emits light that forms a display image to an eyeball of the user by comparing a detection result of movement of the display unit and a detection result of movement of the head.
